(19) United States
(12) Patent Application Publication
(10) Pub. No.: US 2012/0285562 A1
(43) Pub. Date: Nov. 15, 2012

(54) CONTROL MECHANISM FOR A PRESSURIZED SYSTEM

(76) Inventor: BRANDON RICHARDSON, SAN FRANCISCO, CA (US)

(21) Appl. No.: 13/469,007

(22) Filed: May 10, 2012

Related U.S. Application Data
(60) Provisional application No. 61/484,408, filed on May 10, 2011.
(60) Provisional application No. 61/605,108, filed on Feb. 29, 2012.

(51) Int. Cl. F03B 11/00; F16K 31/08

(52) U.S. Cl. 137/561 R; 251/65

(57) ABSTRACT

A control mechanism including a stop element, an attractor element, and an actuation element disposed between the stop element and the attractor element. The actuation element is preferably magnetically attracted to the attractor element, and translates between a first position, proximal the attractor element, and a second position, defined by the stop element. The control mechanism is preferably utilized within a pressurized system, wherein the actuation element actuates a valve in the second position to prevent further pressurization of a pressurized reservoir.

### CROSS-REFERENCE TO RELATED APPLICATIONS

This application claims the benefit of U.S. Provisional Application No. 61/484,408, filed 10 MAY 2011, and U.S. Provisional Application No. 61/605,108, filed 29 FEB. 2012, which are incorporated in its entirety by this reference.

### TECHNICAL FIELD

This invention relates generally to the control systems field, and more specifically to a new and useful pressure-dependent control mechanism in the control systems field.

### BACKGROUND

Pressure-activated actuation mechanisms are commonly used in control systems to cause an electrical or mechanical change of state or to achieve a mechanical motion. These changes are typically a response to a pressure signal, wherein the pressure signal is typically generated when the system pressure exceeds a set threshold. These systems typically include at least two electrical and/or mechanical control components; namely, an actuator responsive to the system pressure reaching a predetermined level, and a pressure-operated two-way valve, actuated by the actuator, that regulates the system pressure. The requirement for these components adds mass, bulk, cost and complexity to the regulated system.

Furthermore, these devices also do not typically provide temperature compensation for material property changes due to temperature variations, and in cases where temperature induced set-point changes are desired, existing systems cannot be configured to facilitate manipulation of the set-point response to an increase or decrease in temperature. Thus, there is a need in the control systems field to create a new and useful control mechanism for pressurized system control.

### BRIEF DESCRIPTION OF THE FIGURES

FIGS. 1A and 1B are schematic representations of the control mechanism in an open and first position, respectively.

FIG. 2 is a schematic representation of a pressurized system in which the control mechanism can be used.

FIG. 3 is a schematic representation of a variation of a method of operation of a pressurized system.

FIG. 4 is a schematic representation of an embodiment of the control mechanism with a position element and a pressure chamber.

FIG. 5 is a schematic representation of a control mechanism with a flux concentrator.

FIGS. 6A and 6B are schematic representations of a second embodiment of the control mechanism in an open and first position, respectively.

FIG. 7 is a graph comparing the different actuation forces applied by: a control system including a magnet as the mobile element; a magnet with a concentrator as the mobile element; and a magnet with a concentrator supplemented with a spring as the mobile element, respectively.

FIG. 8 is a schematic representation of a thermal adjustment and compensation mechanism.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

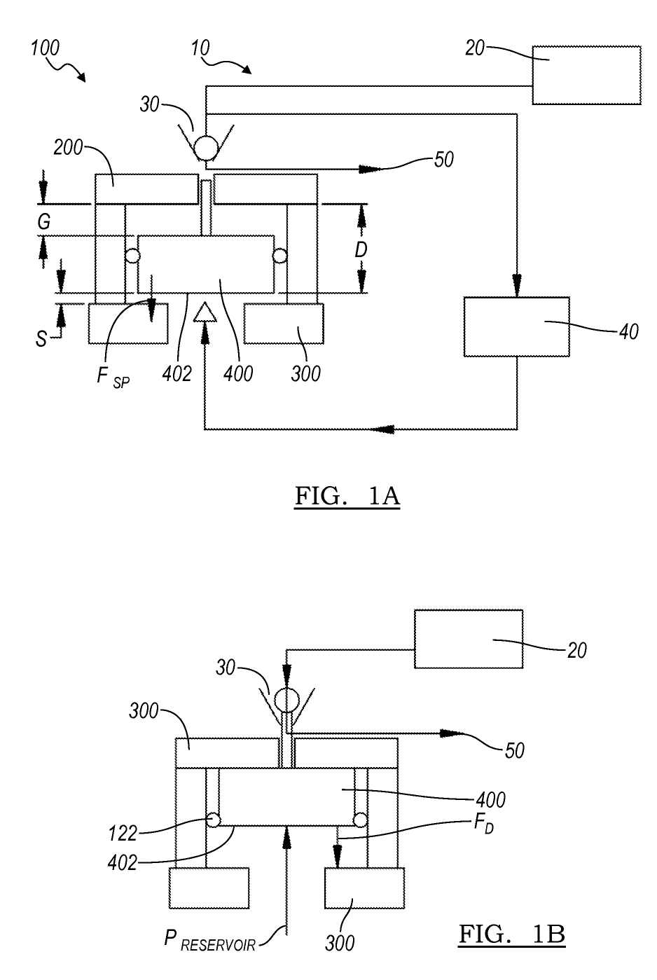

As shown in FIG. 1, a control mechanism 100 for a pressurized system 10 includes a stop element 200; an attractor element 300; and a mobile element 400, disposed between the stop element 200 and the attractor element 300, that is operable between: a first position wherein the mobile element 400 is positioned at a point substantially near the attractor element 300 (first position), as shown in FIG. 1B, and a second position wherein the mobile element 400 is positioned against the stop element 200 (second position) and experiences a attraction force towards the attractor element 300, as shown in FIG. 1A.

The functionalities of the control mechanism 100 are dependent on Fsp, the attraction force between the mobile element 400 and the attractor element 300 at the first position (first position), and Fd, the attraction force between the mobile element 400 and the attractor element 300 at a displaced position (second position, stop position), wherein the mobile element 400 is preferably displaced to the second position, but can be displaced to a position between the second position and first position. Fsp preferably defines the pressure threshold at which the mobile element 400 translates from the first position to the second position. In operation, the mobile element 400 translates from the first to the second position when the force applied by the reservoir 40 pressure on the mobile element 400 exceeds Fsp. Fd preferably defines the pressure threshold at which the mobile element 400 translates from the second position to the first position. In operation, the mobile element 400 preferably translates from the second to the first position when the force applied by the reservoir pressure falls below Fd.

The first position (set position, set point) preferably controls Fsp, wherein the attraction force preferably varies (e.g. degrades) with distance away from the attractor element 300. The first position can also control the purge time (e.g. duration between system pressurizations). The first position is preferably adjustable, and is preferably adjusted to a predetermined distance away from the attractor element 300. Alternatively, the first position can be set at the attractor element 300 (i.e. the mobile element 400 contacts the attractor element 300). The attraction force preferably increases as the distance between the first position and the attractor element 300 decreases (i.e. the mobile element 400 in first position rests nearer the attractor element 300), and decreases as the distance increases.

Fd is preferably controlled by the deadband gap (G), defined between the stop element 200 and the mobile element 400, wherein the attraction force preferably also varies with distance away from the attractor element 300. Fd can also be influenced by the distance between the stop element 200 and the attractor element 300 (D). In one variation, Fd increases when D decreases (e.g. the attractor element 300 is closer to the stop element 200), and decreases when D increases.

Both Fsp and Fd are preferably controlled through control mechanism 100 design (e.g. geometry and material selection), but can alternatively be adjustable (manually or automatically).

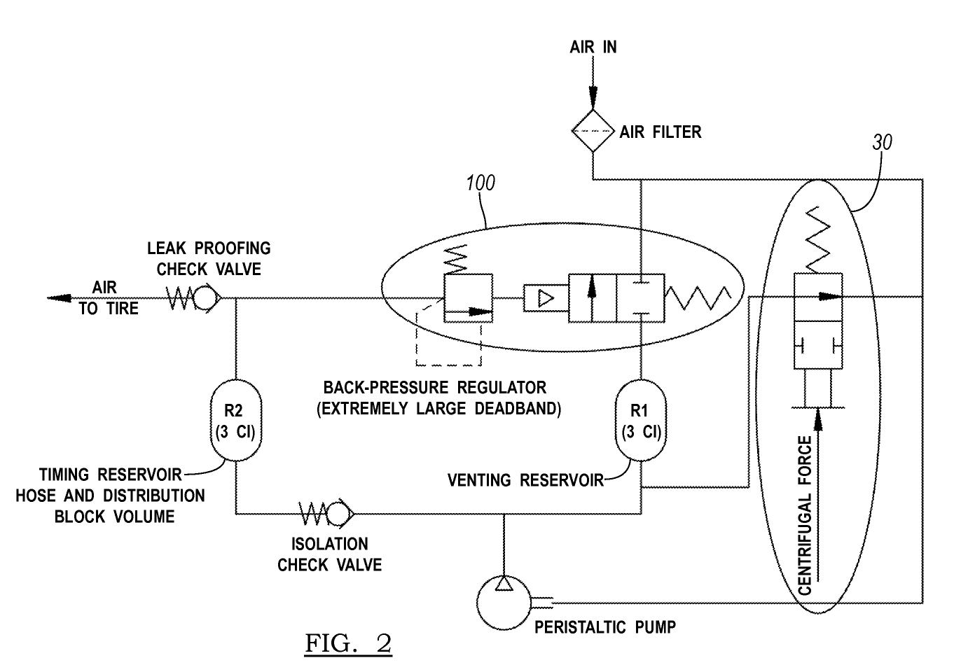

The control mechanism 100 is preferably utilized within a pressurized system 10, such as the one shown in FIG. 2, wherein the control mechanism 100 functions to vent the pressurized system 10 once the pressurized system 10 surpasses a pressure threshold. A portion of the mobile element 400 proximal the attractor element 300 (pressure face 402) is exposed to the pressurized system 10. The mobile element 400 is displaced from the first position to the second position when the force applied by the system pressure (Fp) exceeds the attraction force between the attractor element 300 and the mobile element 400 in the first position (Fsp), and switches back to the first position once the system pressure falls below the attraction force at the second position (Fd). The control mechanism 100 preferably vents the system in the second position, and permits system pressurization in the first position.

The control mechanism 100 can additionally function to control the pressure to which the system is vented through control of Fd, as venting is ceased only when force applied by the system pressure falls below Fd. As aforementioned, Fd can be adjusted by adjusting the set point and/or the distance between the stop and attractor elements 300. In one variation, the system pressure is raised by increasing Fd and decreased by decreasing Fd.

The control mechanism 100 can additionally function as a timer for the pressurized system 10. More specifically, the control mechanism 100 can control the duration between pressurization cycles. This is particularly desirable when the pressurization mechanism 20 is in constant operation. In one variation, the venting valve 30 is retained in an open position for a portion of the mobile element transition from the second position to the first position, such that the system is vented not only when the mobile element 400 is in the second position but for a period afterwards as well. The time for mobile element transition back to the first position is preferably dependent on the relative strengths (magnitudes) of the attraction force at the second position and the force applied by the pressure of the system (which the mobile element 400 preferably still experiences while in the second position).

The control mechanism 100 can also function as a pressure-based actuator, wherein the mobile element 400 actuates an auxiliary element in one of the operational configurations. In one embodiment, the mobile element 400 actuates the auxiliary element when the mobile element 400 moves from the first position to the second position.

The control mechanism 100 can also function as a switch, wherein the stop element 200 surface proximal the mobile element 400 includes a contact, and the corresponding surface of the mobile element 400 includes a contact. The switch is closed when the mobile element 400 is in to the second position (i.e. the contacts couple), and opened when the mobile element 400 is in the first position. In another embodiment, the attractor element 300 or position element 500 includes a contact, wherein the switch is closed in the first position. The control mechanism 100 can be particularly useful as an electrical pressure switch, wherein the snap action of the fluid pressure overcoming the attraction force at the set point can increase the accuracy of the pressure switch, and can additionally increase the lifetime of the contacts due to decreased arc erosion.

As a person skilled in the art will recognize, the control mechanism 100 can be utilized for other pressure-dependent functionalities.

The pressurized system 10 that utilizes the control mechanism 100 preferably includes a pressurization mechanism 20, a reservoir 4o containing a pressurized fluid, and a valve 30 coupled to the reservoir 40, wherein the valve 30 vents the pressurized fluid to the ambient environment when placed in an open position. The pressurization mechanism 20 is preferably a pump that pressurizes the reservoir 40 by pumping fluid into the reservoir 40. The pressurization mechanism 20 is preferably a positive displacement pump, such as a peristaltic pump, screw pump, or plunger pump, but can alternatively be any other suitable displacement device. The pressurization mechanism 20 is preferably continuously operated during operation of the pressurized system 10 (e.g. the pump is constantly pumping), but can alternatively be periodically operated over the course of pressurized system operation. The pressurized fluid is preferably air, but can alternatively be a liquid such as water, refrigerant, or oil, or be any other suitable compressible fluid.

The valve 30 is preferably fluidly coupled to the pressurization mechanism 20 and an outlet 50, wherein the valve 30 controls fluid flow between the pressurization mechanism 20 and the outlet 50. Alternatively, the valve 30 can additionally control fluid flow between the pressurization mechanism 20 and the reservoir 40. The valve 30 is preferably operable between a closed position and an open position. In the closed position, the valve 30 preferably blocks fluid flow between the pressurization mechanism 20 and the outlet 50, and permits fluid flow between the pressurization mechanism 20 and the reservoir 40. In the open position, the valve 30 preferably permits fluid flow between the pressurization mechanism 20 and an outlet 50. Pressurized fluid preferably flows out the outlet 50 due to the lower pressure of the outlet 50 relative to the reservoir 40. However, the valve 30 can additionally block the fluid connection between the pressurization mechanism 20 and the reservoir 40 to facilitate fluid flow out the outlet 50. The valve 30 preferably includes a valve member that couples to a seat to seal a port. The valve 30 can be a one-way valve, two-way valve, or any other suitable valve. The valve 30 is preferably a Poppet valve, but can be any suitable passive or active valve. The valve 30 preferably includes a return mechanism that closes the valve 30 after valve body displacement. In one variation, the valve 30 includes a return spring, wherein the spring constant is selected to achieve the desired purge time with the applied force from the mobile element 400 (e.g. the spring is soft enough to allow the mobile element 400 to keep the valve 30 open for a majority of the transition from the second position to the first position). In another variation, centripetal force closes the valve 30, wherein the pressurized system 10 rotates or rotates with a rotating surface.

The reservoir 40 preferably functions to hold and pressurize fluid as fluid is pumped in by the pressurization mechanism 20. The reservoir 40 is preferably coupled to a system that requires pressurized fluid, such as the wheel of a tire. Alternatively, the reservoir 40 is the system (e.g. tire) itself. The reservoir 40 is preferably fluidly coupled to the pressurization mechanism 20 by a valve, more preferably a one-way valve, that permits fluid flow into the reservoir 40. The pressurized system 10 preferably includes one reservoir 40, but can alternatively include multiple reservoirs. For example, the system 10 can include a first pressurized reservoir that receives fluid from the pressurization mechanism 20, and a second reservoir that is fluidly coupled to the pressure chamber 120. In this example, the first reservoir is preferably fluidly coupled to the second reservoir (e.g. by a valve), wherein the second reservoir can be a tire or any other suitable system that requires pressurization.

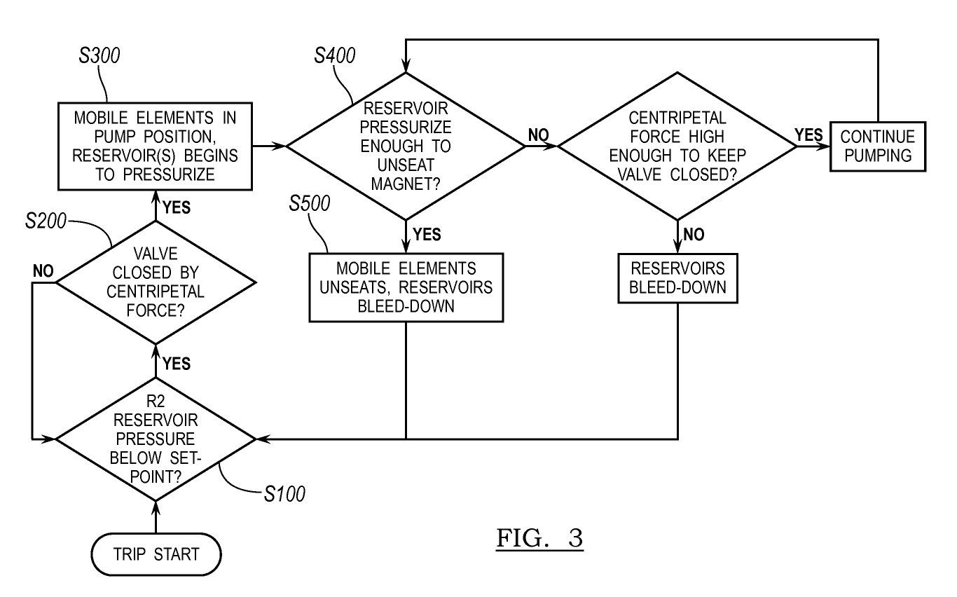

In one example of pressurized system operation as shown in FIG. 3, the pressurization mechanism 20 pumps fluid into the reservoir 40 (S300) while the reservoir pressure is below the threshold pressure (S100). During this period, the control mechanism 100 is preferably in the first position, and the valve 20 is preferably closed (S200), preventing fluid flow from the pressurization mechanism 20 to the outlet 50. When the reservoir pressure hits the threshold pressure (S400), the control mechanism 100 switches from the first position to the second position and places the valve 20 in an open position (S500). The valve 20 preferably redirects fluid flow from the pressurization mechanism 20 to the outlet, preventing further reservoir pressurization. The reservoir 40 then preferably slowly bleeds down due to leakage, slowly vent through a valve (e.g. the valve connecting the pressurization mechanism to the reservoir, the valve 20, a bleeding valve, etc.), or slowly bleed down in any other suitable manner. The control mechanism 100 preferably switches back to the first position when the reservoir pressure falls below a pressure that can overcome Fd (S100), allowing the valve 20 to return back into the closed position (S200). In this variation, pressurized fluid from the pressurization mechanism 20 and/or reservoir preferably does not flow through the control mechanism during venting. However, the pressurized system 10 can have any other suitable configuration.

As shown in FIG. 1, the stop element 200 of the control mechanism 100 defines the maximum displacement position of the mobile element 400, and prevents further mobile element displacement away from the attractor element 300. The stop element 200 is preferably arranged substantially near the valve 30 of the pressurized system 10, wherein the valve 30 is actuated when the mobile element 400 is proximal the valve 30. However, the stop element 200 can be arranged in any other suitable location within the pressurized system 10, particularly when the control mechanism 100 functions as an electrical switch. The stop element 200 is preferably a plate, but can alternatively be a plate with a through-hole; one or more overhanging extensions; or have any other suitable geometry that prevents further displacement of the mobile element 400 away from the attractor element 300. The stop element 200 preferably has a similar geometry to the mobile element profile (e.g. if the mobile element 400 is circular, the plate is preferably circular as well), but can alternatively be substantially different. If the stop element 200 includes a through-hole or aperture, the aperture width is preferably smaller than the mobile element diameter/width. The stop element 200 is preferably inert to the mobile element 400, and does not exert an attractive force over the mobile element 400. The stop element 200 is preferably non-ferrous. Alternatively, the stop element 200 can exert a repulsive force on the mobile element 400, or can exert a small attractive force, weaker than Fd applied by the attractor element 300, on the mobile element 400. The stop element 200 is preferably made of stainless steel, but can alternatively be made of aluminum, polymer, or any suitable material that is substantially rigid and can withstand multiple loading cycles.

As shown in FIGS. 6A and 6B, the stop element 200 can additionally include one or more return elements 220 disposed proximal the mobile element 400 (e.g. between the stop element 200 and the mobile element 400) to alter the first and second positions and/or adjust the threshold pressures at which the mobile element 400 translates between the first and second positions. In one variation, the return element 220 includes a biasing spring, which can additionally extend the stroke length of the mobile element 400. Depending on the spring configuration, the spring can additionally define the first and second positions. The first position can be defined by the recovery force of the extended spring, and/or the second position can be defined by the reaction force of the compressed spring. For example, the first position can be the position at which the attraction force between the mobile element 400 and the attractor element 300 is substantially equal to the spring recovery force. Likewise, the second position can be the position at which the force provided by the reservoir pressure is substantially equivalent to the spring reaction force. Furthermore, dependent on the spring configuration, the spring can decrease Fsp by supplementing the force applied by the system pressure on the mobile element, such that the mobile element 200 transitions from the first to the second position at a lower applied pressure. Alternatively/additionally, the spring can supplement Fd, such that the mobile element 200 transitions from the second to the first position at a higher applied pressure. For example, the spring can be selected or configured such that the spring rest position (equilibrium position) is substantially near the second position. When the mobile element 400 is in the first position, the spring is extended and facilitates movement toward the second position (e.g. reduces the threshold pressure at the first position). However, the spring can be configured such that the rest position is substantially near the first position, between the first and second positions, or in any other suitable configuration. In another variation, the return element can alternatively be the stop element 200, wherein the stop element 200 exerts a repulsive force against the mobile element 400. Alternatively, the return element 220 can be any other suitable mechanism that returns the mobile element 400 to the first position. The return element 220 can additionally be adjustable, such that the location of the second position within the control mechanism 100 is adjustable and/or the amount that the return element 220 alters the displacement force and/or actuation force is adjustable. In one variation of the control mechanism, the return element 220 includes one or more springs, wherein the compression of the spring in the rest/equilibrium position is adjustable to increase or decrease the supplemental force (e.g. more compressed to lower the supplemental force, less compressed to increase the supplemental force). In this variation, the return element 220 can include a mechanism that adjusts the spring compression (e.g. an adjustable bracket coupled to the free end of the spring, wherein the height of the bracket is adjustable through a screw mechanism, ratcheting mechanism, etc.). Alternatively, any other suitable aspect of the springs, such as the spring constants, can be adjustable. However, the return element 220 can include any other suitable adjustment mechanism that adjusts the amount of supplemental force provided by the return element 220 to the displacement force.

The attractor element 300 of the control mechanism 100 functions to apply an attraction force on the mobile element 400. The attraction force is preferably variable with distance away from the attractor element 300. More preferably, the attraction force decreases with distance. However, the attraction force can be substantially constant along the mobile element displacement path, or can increase with distance away from the attractor element 300. The attraction force is preferably substantially constant over multiple displacement cycles, wherein mechanism that creates the attraction force is preferably fatigue and set resistant over a given number of cycles. The attractor element 300 is preferably a ferrous element, such as a ferrous plate or a permanent magnet, wherein the mobile element 400 is also ferrous, and can also be a magnet. However, the attractor element 300 can be a plate with one or more springs coupled to the mobile element 400, a set of springs disposed between the stop element 200 and mobile element 400, or any other suitable mechanism that can exert an attraction over force over the mobile element 400 as the mobile element 400 is displaced, or any suitable combination of the above. The attractor element 300 is preferably a plate, disc, or any suitable prism, but can alternatively have any suitable configuration. The attractor element 300 preferably has substantially the same geometry as the stop element 200, but can alternatively have a different geometry.

The attractor element 300 is preferably positioned a predetermined distance (D) from the stop element 200, wherein D is preferably substantially equivalent to the sum of the first position (S), the mobile element thickness, and the deadband gap (G), but can alternatively be larger. The attractor element 300 is preferably substantially statically coupled relative to the stop element 200, but can alternatively be mobile relative to the stop element 200. In one variation of the control mechanism 100, the attractor element 300 is statically coupled to the stop element 200 by a coupling member 620. The coupling member 620 can be the casing walls, one or more support members, or any other suitable rigid coupling member 620. In another variation, the attractor element 300 is movably coupled to the stop element 200 by a coupling member 620, wherein the coupling member 620 can include guide grooves, latches, threading, or any other suitable feature by which the attractor element 300 position can be adjusted.

The attractor element 300 can additionally facilitate pressure application to the pressure face 402 of the mobile element 400. In one variation of the control mechanism 100, the pressure face 402 is the face of the mobile element 400 adjacent the interior face of the attractor element 300, wherein the interior attractor element 300 face is the face proximal the stop element 200. In this variation, the attractor element 300 can include a hole through the attractor element thickness that allows the pressurized fluid to contact the mobile element face. In another variation of the control mechanism 100, the mobile element 400 can include a pressure piston 420 that extends through a through-hole in the attractor element 300. The pressure piston 420 can extend into a pressure chamber 120, defined by the attractor element 300 (specifically, the face distal the stop element 200), a base 520, and a casing wall, wherein the pressurized fluid pressurizes the pressure chamber 120 and applies pressure to the piston end. This embodiment can additionally include a sealing element 122, such as an O-ring, between the piston 420 and the attractor element 300 to facilitate pressurization of the pressure chamber 120. In a third variation, the attractor element 300 includes a groove on the surface proximal the mobile element 400, wherein the groove and mobile element 400 cooperatively define a pressurization chamber, and pressurized fluid from the reservoir 40 is fed into said groove. This embodiment can be utilized when the first position is at the attractor element 300 (i.e. the mobile element 400 contacts the attractor element 300). However, pressure from the pressurized system 10 can be applied to any suitable mobile element face.

The mobile element 400 of the control mechanism 100 translates between the first and second positions, and preferably functions to actuate the valve 30 of the pressurized system 10. The mobile element 400 (actuation element, translating element) is preferably arranged between the stop element 200 and the attractor element 300. In the second position, the mobile element 400 preferably substantially contacts the stop element 200. In the first position, the mobile element 400 is preferably positioned substantially near the attractor element 300, but is separated from the attractor element 300 by the first position (S). The distance between the mobile element 400 and the stop element 200 in the first position is preferably the deadband gap (G).

Mobile element translation within the control mechanism 100 is preferably guided by the coupling member 620 that couples the stop element 200 to the attractor element 300. The coupling member 620 is preferably spaced a distance away from the mobile element 400 sides, such that the mobile element 400 can transition freely between the open and first positions, but can alternatively couple to the mobile element 400 sides, wherein the coupling member 620 can include lubricant on the mobile element 400-contacting walls to facilitate mobile element transition. The coupling member 620 can alternatively include longitudinal guide grooves that facilitate and guide mobile element translation, or any other suitable guiding mechanism. The coupling member 620 can additionally include a sealing element 122, such as an O-ring, between the coupling member 620 and the mobile element 400, such that the mobile element 400 and coupling member 620 cooperatively form a seal that substantially prevents fluid flow through the control mechanism 100.

The mobile element 400 is preferably attracted to the attractor element 300. The mobile element 400 is preferably a magnet, wherein the attractor element 300 can be a ferrous plate. The mobile element 400 is preferably a permanent magnet, and can be a composite magnet or a rare earth magnet. Examples of magnets that can be used include neodymium-iron-boron (NIB) magnets, ferrite, and samarium-cobalt magnets. However, the mobile element 400 can alternatively be an electromagnet, or an inert plate. As shown in FIG. 5, the magnet can additionally include a magnetic flux concentrator 320 (flux intensifier, diverter, controller, etc.) that focuses the magnetic flux towards the attractor element 300. In one embodiment, the flux concentrator 320 is an open enclosure that substantially surrounds the magnet, with the opening facing the attractor element 300. However, the flux concentrator 320 can be a plate, bar, wire wound about the circumference of the magnet, or any suitable flux concentrator 320. The flux concentrator 320 is preferably metallic and magnetic, but can alternatively be magnet-impregnated polymer or any suitable material. The flux concentrator 320 is preferably a lamination on the magnet sides and face proximal the stop element 200, but can alternatively be any suitable flux concentrator 320 in any suitable configuration. The mobile element 400 is preferably a disc, but can alternatively be any suitable geometry. The mobile element 400 preferably includes a pressure face 402, proximal the attractor element 300, which is coupled to the pressurized fluid. The mobile element 400 preferably includes an actuation face on the opposing surface of the pressure face 402 (e.g. face proximal the stop element 200).

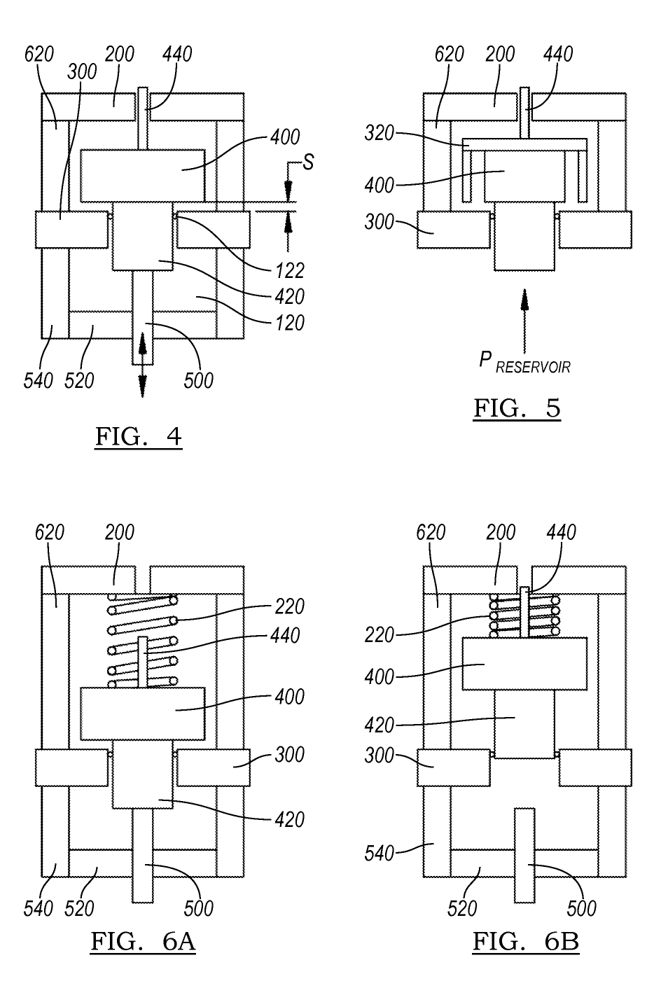

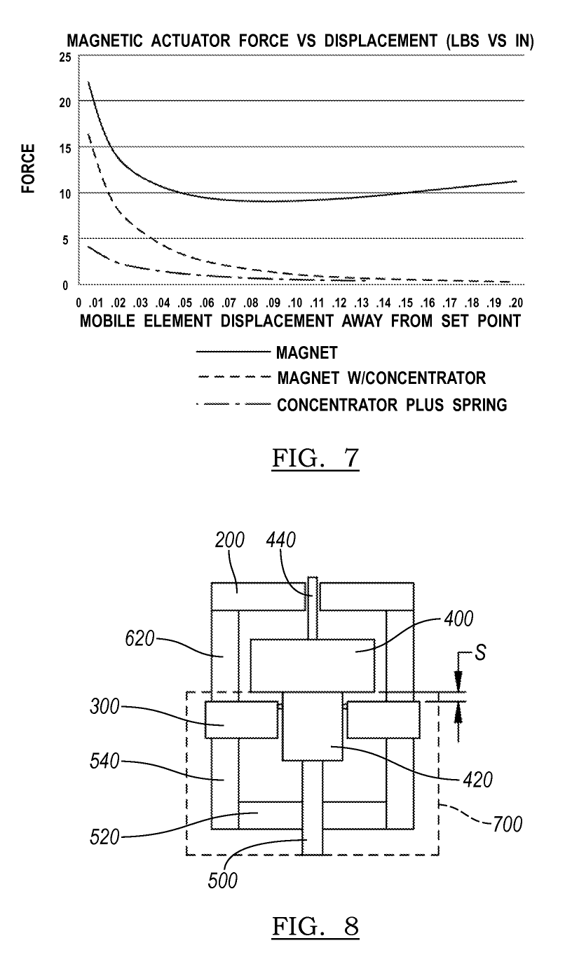

The mobile element 400 can additionally include a pressure mechanism 420 that functions to transmit the force applied by the pressurized fluid to the mobile element 400. In one variation of the control mechanism 100, as shown in FIG. 4, the pressure mechanism 420 is a piston 420 that extends through a hole in the attractor element 300. The piston 420 is preferably located substantially at the center of the pressure mechanism 420, and preferably extends through the center of the attractor element 300 to access the pressurized fluid in the first position. The piston 420, particularly the area of the end face exposed to the pressurized fluid (pressurized end), is preferably dimensioned to generate adequate force (Fp) at the threshold pressure to overcome the attraction force between the mobile and attractor elements 300 at the set point (Fsp). In a second embodiment, the pressure mechanism 420 is simply a portion of the pressure face 402. However, other pressure-transmission mechanisms can alternatively be used.

The mobile element 400 can additionally include an actuation mechanism 440 that functions to actuate the valve 30. In one variation, the mobile element 400 body is actuation mechanism 440, wherein the valve body of the valve 30 is ferrous and is repelled by the magnetic mobile element 400. In a second variation, as shown in FIG. 4, the actuation mechanism 440 is a rod coupled to the actuation face of the mobile element 400, wherein the rod unseats the valve body when the mobile element 400 is moved to the second position. The rod is preferably longer than the thickness of the stop element 200, and preferably extends through the stop element 200 to actuate the valve body. Furthermore, the rod is preferably dimensioned to retain the valve 30 in an open position for a portion of the mobile element transition back to the first position. For example, the rod length can be substantially equivalent to the sum of the stop element thickness and the deadband gap, wherein the valve 30 is kept open for the entire time the mobile element 400 is transitioning back to the first position. However, the rod can be any suitable length. Alternatively, any other suitable actuation mechanisms can be used.

The control mechanism 100 can additionally include a position element 500 that functions to define the first position. Through control of the first position, the position element 500 also controls the pressure threshold and can also control the purge time and/or duration between pressurization cycles. The position element 500 preferably couples to the face of the mobile element 400 proximal the attractor element 300 (pressure face 402) to maintain the mobile element 400 at the first position. More preferably, the position element 500 couples to the pressure mechanism 420 of the mobile element 400, such as the piston 420. The position element 500 preferably abuts against the mobile element 400 in the first position, but can alternatively apply a repulsive force, preferably smaller than the attraction force applied by the attraction element, to place the mobile element 400 in the first position. The repulsive force can be applied by springs, magnetic fields (e.g. persistent or transient), or any other suitable means.

The position of the position element 500 relative to the attractor element 300 is preferably adjustable, wherein position adjustment preferably results in first position adjustment. The position of the position element 500 is preferably adjustable from the control mechanism exterior, but can alternatively be adjusted from the control mechanism interior, electronically adjusted, or adjusted in any suitable manner. The position element 500 preferably couples to a complimentary feature within a retention mechanism to transiently maintain the position, as shown in FIG. 4. The retention mechanism is preferably a base 520, wherein the base 520 is preferably statically positioned relative to the attractor element 300 by a spacing mechanism 540 on the side of the attractor element 300 that opposes the stop element 200, but can alternatively be movably positioned relative to the attractor element 300. Alternatively, the retention mechanism can be the attractor element 300. In one variation, the position element 500 is a screw, wherein the end of the screw body couples to the mobile element 400 face. The screw head is preferably external the control mechanism 100, such that a user can manually set the first position by turning the head of the screw. The position of the position element 500 is preferably retained within a threaded hole in the retention mechanism. In another variation, the position element 500 is toothed, wherein the retention mechanism preferably includes a complimentarily toothed hole, such that the position element 500 and retention mechanism form a ratcheting system. In another variation, the position element 500 is statically coupled to the base 520, wherein the base 520 moves relative to the attractor element 300 to adjust the first position. However, the control mechanism 100 can include any other suitable adjustable position element 500.

Alternatively, the position element 500 can be static relative to the attractor element 300. In this variation, the position element 500 is preferably permanently connected to or formed as a singular piece with the retention mechanism (e.g. casing 600, base 520 or attractor element 300). For example, the position element 500 can include one or more flanges extending from the casing walls substantially near the attractor element 300, wherein the flanges can couple to a portion of the circumferential edge of the mobile element face. In another example, the position element 500 can include a stand extending from the attractor element 300 face. However, the control mechanism 100 can include any other suitable static position element 500.

As shown in FIG. 8, the control mechanism 100 can additionally include a thermal compensation mechanism 700 that compensates for system variations due to temperature fluctuations. More specifically, the thermal compensation mechanism 700 accommodates for the changes in attraction force due to thermal variation (which, in turn, directly influences Fsp). For example, the magnitude of the magnetic field between the attractor element 300 and the mobile element 400 decreases with increased temperature and increases with decreased temperature. This can cause the control system to vent the pressurized system 10 before the system pressure reaches the desired pressure threshold. The thermal compensation mechanism 700 preferably compensates for these effects by adjusting the first position in response to a temperature change in the control mechanism 100. More preferably, the thermal compensation mechanism 700 adjusts the first position to maintain the Fsp at the desired pressure threshold. The thermal compensation mechanism 700 preferably adjusts the first position passively, but can alternatively actively adjust the first position (e.g. through a powered system). The thermal compensation mechanism 700 preferably decreases the first position in response to a temperature increase, bringing the mobile element 400 closer to the attractor element 300 and increasing the attraction force on the mobile element 400 relative to the uncompensated attraction force, wherein the compensated attraction force preferably corresponds to the desired pressure threshold (e.g. the total magnetic flux on the mobile element 400 is preferably substantially maintained). The thermal compensation mechanism 700 preferably increases the first position for a temperature decrease. Changes in the first position on the order of 0.2%/° C. can be preferable. The thermal compensation mechanism 700 preferably leverages the thermal properties of the control mechanism 100 materials to change the first position. In the variation wherein the position element 500 is retained by retention mechanism, the spacing mechanism 540 that maintains the retention mechanism position relative to the attractor element 300 preferably expands and retracts in response to an increase and decrease in temperature, respectively. The material and dimensions of the spacing mechanism 540 are preferably selected to achieve the desired first position change. For example, the material can be one or more metals, ceramics, or polymers, wherein the material or combination thereof is tailored to achieve the desired coefficient of expansion. Furthermore, the dimensions and materials of the through-hole in the attractor element 300 and the pressure piston 420, if used, are preferably selected such that the attractor element 300 does not bind the piston 420 due to thermal expansion within the operating conditions of the pressurized system 10 (e.g. the positioning element and piston dimensions do not substantially vary with temperature). The thermal compensation mechanism 700 preferably additionally compensates for the changes in piston length (e.g. the amount of spacing mechanism expansion is preferably larger than the amount of piston lengthening in response to a temperature increase).

Alternatively, a control system with a temperature-variable Fsp/attraction force can be desired, particularly in systems that require an active thermal response. In one variation of the control mechanism 100, a temperature-variable attraction force is achieved by omitting the temperature compensation mechanism. This will cause the attraction force to be dependent on the inherent temperature characteristics of the mobile element 400 and attractor element 300. For example, if NDFeB magnets are used, then the Fsp/attraction force will vary inversely with temperature, decreasing with a temperature increase (resulting in a lower pressure threshold), and increasing with a temperature decrease (resulting in a higher pressure threshold). In this first variation, the first position preferably stays substantially constant (e.g. the position element 500 does not substantially change in length), and only the force interactions between the mobile element and attractor element change. In a second variation, the temperature-variable attraction force is achieved by adjusting the first position to decrease the attraction force with a temperature increase, and to increase the attraction force with a temperature decrease. In this variation, the position element 500 and/or piston 420 is the temperature compensation mechanism. Expansion of the position element 500/ piston 420 with a temperature increase preferably results in first position increase, and thus, attraction force decrease. Contraction of the position element 500/piston 420 with a temperature decrease preferably results in first position decrease and attraction force increase. In this variation, the position element 500 and/or piston 420 is preferably made of metal (e.g. aluminum, steel, stainless steel, brass, etc.), but can alternatively/additionally be made of glass, ceramic, polymer, or any other suitable material that exhibits thermal expansion and/or contraction.

The control mechanism 100 can additionally include a casing 600 that couples to, defines, and/or maintains the relative positions of the control mechanism 100 components. The casing 600 can additionally encapsulate and mechanically protect the control mechanism 100 components. The casing 600 can also define the pressure chamber 120. The casing 600 preferably statically maintains the distance between the attractor element 300 and the stop element 200. The casing 600 preferably includes attractor element-coupling features, such as grooves, that couple to and retain the attractor element 300. The casing 600 preferably additionally defines the stop element 200, wherein the stop element 200 can be flanges, a ring, or any other suitable feature that extends toward the central axis of the casing 600 from the casing walls. Alternatively, the casing 600 can include stop element-coupling features, such as grooves or clips, that couple to and retain the stop element 200. The casing 600 can additionally include the base 520 that retains the position element 500 and the spacing mechanism 540 that controls the spacing between the base 520 and the attractor element 300. The casing 600 preferably defines the base 520 and spacing mechanism 540, wherein a substantially sealed-off end of the casing 600 defines the base 520, and the casing walls preferably define the spacing mechanism 540. However, other portions of the casing 600 can alternatively define the base 520 and spacing mechanism 540. Alternatively, the casing 600 includes base- and spacing mechanism-coupling features, such as grooves, clips, threaded through-holes, or any other suitable coupling feature that couple to and retain the base 520 and spacing mechanism 540.

In one preferred embodiment, as shown in FIG. 4, the control mechanism 100 includes a non-ferrous plate as a stop element 200, a ferrous plate as an attractor element 300, and a magnetic disc as a mobile element 400. The attractor element 300 is statically positioned a distance away from the stop element 200 by a casing 600, which also functions to enclose and protect the magnet. The magnet is configured to be attracted to the attractor plate 300, and includes an actuation rod disposed on the face proximal stop element 200, wherein the rod extends though a hole through the center of the stop plate 200; and a pressure piston 420 that extends through a hole in the attractor plate 300. The control mechanism 100 additionally includes a pressure chamber 120 encapsulating the end of the piston 420 distal from the mobile element 400. The pressure chamber 120 is cooperatively defined by the attractor plate 300, a retention plate that functions as the base 520, and a second portion of the casing 600 that functions as the spacing mechanism 540. The second portion of the casing 600 further functions as the thermal compensation mechanism 700, and adjusts the distance between the attractor and retention plates in response to a temperature change. The pressure chamber 120 additionally includes a position element 500 that extends through a hole in substantially the center of the retention plate, wherein the position element 500 abuts against the end of the pressure piston 420 to control the first position of the mobile element 400 relative to the attractor plate 300. The position element 500 is preferably a screw, and the first position is preferably increased by advancing the screw into the pressure chamber 120, and decreased by backing the screw out of the pressure chamber 120. The position element 500 and piston 420 preferably have smaller coefficients of expansion than the second portion of the casing 600 to facilitate temperature compensation.

As a person skilled in the art will recognize from the previous detailed description and from the figures and claims, modifications and changes can be made to the preferred embodiments of the invention without departing from the scope of this invention defined in the following claims.

I claim:

1. A pressurized system comprising:
an inlet;
a reservoir fluidly coupled to the inlet;
an outlet fluidly coupled to the inlet;
a valve, operable between:
a first position, wherein the valve permits flow between the inlet and reservoir and blocks flow between the inlet and the outlet;
a second position, wherein the valve permits flow between the inlet and the outlet and blocks flow between the inlet and the reservoir;
a control mechanism comprising:
a housing comprising:
a stop element disposed proximal the valve;
an attractor element, comprising a ferrous plate, disposed distal the valve;
an actuation element, disposed between the stop element and attractor element and coupled to the valve, the actuation element operational between:
a first position, proximal the attractor element, that places the valve in the first position, wherein the actuation element is magnetically attracted toward the attractor element and the first position; and
a second position, defined by the stop element, that places the valve in the open position;
the housing, actuation element and attractor element cooperatively defining a pressure chamber, wherein the pressure of the pressure chamber is fluidly coupled to the reservoir.

2. The pressurized system of claim 1, wherein the housing further comprises a position element that defines the first position.

3. The pressurized system of claim 2, wherein the attractor element further comprises a through-hole, wherein the actuation element abuts against the position element through the through-hole.

4. The pressurized system of claim 3, wherein the actuation element further comprises a piston that extends from the actuation element and abuts against the position element through the through-hole.

5. The pressurized system of claim 2, wherein the position element comprises a threaded body.

6. The pressurized system of claim 2, wherein the housing further comprises a base transiently maintaining a position of the position element relative to the attractor element.

7. The pressurized system of claim 6, wherein the position of the position element is adjustable, wherein adjustment of the position element position adjusts the first position.

8. The pressure system of claim 6, wherein the housing further comprises a support element connecting the base to the attractor element, wherein the support element increases a distance between the base and attractor element in response to a temperature increase, and decreases the distance between the base and attractor element in response to a temperature decrease.

9. The pressurized system of claim 8, wherein the support element, actuation element, attractor element and base cooperatively define the pressure chamber, wherein the actuation element translates from the first position to the second position in response to a force applied by pressure within the pressure chamber exceeding an attractive force between the attractor element and the actuation element.

10. The pressurized system of claim 1, wherein the actuation element comprises a permanent magnet, oriented to cause an attractive force between the actuation element and the attractor element.

11. The pressurized system of claim 10, wherein the attractor element comprises a permanent magnet.

12. A control mechanism comprising:
a stop element;
a attractor element axially disposed distal the stop element;
a thermal compensation element comprising:
a position element;
a base transiently maintaining the position of the position element relative to the attractor element;
a support element connecting the base to the attractor element, wherein the support element increases a distance between the base and attractor element in response to a temperature increase, and decreases the distance between the base and attractor element in response to a temperature decrease;
an actuation element disposed between the stop element and the attractor element, the actuation element operational between:
a first position defined by the position element, wherein a persistent magnetic field attracts the actuation element toward the first position and the attractor element; and
a second position, defined by the stop element.

13. The control mechanism of claim 12, wherein the attractor element is located between the stop element and the base, wherein the position element extends from the base towards the attractor element, and wherein the attractor element includes a through-hole through which the position element couples to the actuation element.

14. The control mechanism of claim 13, wherein the actuation element further comprises a piston that extends through the through-hole to couple to the position element.

15. The control mechanism of claim 12, wherein the position element comprises the end of a cylindrical body that extends axially through the pressure regulator.

16. The control mechanism of claim 15, wherein the base comprises a threaded through-hole and the position element comprises a threaded body, wherein rotation of the position element adjusts the position of the position element within the housing.

17. The control mechanism of claim 12, wherein the attractor element comprises a ferrous plate and actuation element comprises a permanent magnet.

18. A control mechanism comprising:
a housing comprising a stop element and a return element connected to a broad face of the stop element;
an actuation element that translates between:
a first position, distal the stop element;
a second position, defined by the return element;
a persistent magnetic field that biases the actuation element toward the first position.

19. The control mechanism of claim 18, further comprising a position element extending axially through the housing, wherein an end of the position element defines the first position, wherein the magnetic field biases the actuation element against the position element.

20. The control mechanism of claim 18, wherein the persistent magnetic field is generated between an attractor element, comprising a ferrous plate, and the actuation element, comprising a permanent magnet; wherein the actuation element is attracted to the attractor element, and wherein the actuation element is disposed between the return element and the attractor element.

21. The control mechanism of claim 18, wherein the return element comprises a spring, wherein the second position is defined by the reaction force of the compressed spring.

22. The control mechanism of claim 21, wherein the compression of the spring at a rest position is adjustable.
